(19) United States
(12) Patent Application Publication
(10) Pub. No.: US 2007/0163511 A1
(43) Pub. Date: Jul. 19, 2007

(54) Multiple Function Animal Furniture System

(76) Inventor: Dan Dietz, Houston, TX (US)

Correspondence Address: TUMEY, L.L.P., P.O. BOX 22188, HOUSTON, TX, 77227-2188, US

(21) Appl. No.: 11/459,868

(22) Filed: Jul. 25, 2006

Related U.S. Application Data
(63) Continuation-in-part of application No. 11/456,817, filed on Jul. 11, 2006.
Application No. 11/456,817 is a continuation-in-part of application No. 11/455,489, filed on Jun. 19, 2006.
Application No. 11/455,489 is a continuation-in-part of application No. 11/438,040, filed on May 19, 2006.
Application No. 11/438,040 is a continuation-in-part of application No. 11/287,716, filed on Nov. 28, 2005.
Application No. 11/287,716 is a continuation-in-part of application No. 11/121,797, filed on May 4, 2005.

(51) Int. Cl. A01K 31/04

(52) U.S. Cl. 119/479

(57) ABSTRACT

An animal housing is disclosed. In an embodiment, the animal housing comprises a top and a plurality of sides. The plurality of sides may provide support to the top. The animal housings further comprises a base. In addition, the plurality of sides may be secured to the base by magnetic force.

### CROSS-REFERENCE TO RELATED APPLICATIONS

This application is a continuation-in-part application of U.S. application Ser. No. 11/456,817 filed on Jul. 11, 2006, which is a continuation-in-part application of U.S. application Ser. No. 11/455,489 filed on Jun. 19, 2006. Which is a continuation-in-part application of U.S. application Ser. No. 11/4380,040 filed on May 19, 2006, which is a continuation-in-part application of U.S. application Ser. No. 11/287,716 filed on Nov. 28, 2005, which is a continuation-in-part application of U.S. application Ser. No. 11/121,797 filed on May 4, 2005, which are each herein incorporated by reference in their entirety.

### STATEMENT REGARDING FEDERALLY SPONSORED RESEARCH OR DEVELOPMENT

Not applicable.

### BACKGROUND OF THE INVENTION

1. Field of the Invention

This invention relates to furniture for an animal and in particular to a piece of furniture that has multiple configurations and can function in multiple ways to accommodate various desires of the animal at any stage of growth. More particularly, this furniture structure and system may function as living quarters for smaller animals such as puppies during house training periods, a storage location for objects related to the animal, as an animal bed, a sitting bench for humans or animals, and/or as an animal step for getting into a human bed.

2. Background of the Invention

For many people, pet animals are members of the family. Some of these pets live inside the home with the owner and have accessories designed for the animal. As with the conventional dog houses, some of the furnishings provide a place for the animal to dwell as well as provide a storage place for the animal's toys. A conventional piece of animal furniture is a bed. There have been many types of animal beds, which are available in various designs. Some of the designs include beds shaped as different types oaf animals. Many beds in the form of animal designs are made of a cushion material to facilitate animal comfort.

Although the animal bed is a common piece of furniture for the inside pet, animals do more than just sleep. For instance, cats usually have a litter box for waste. Pets also have toys with which they play. In addition, some pets may prefer to climb on the owner's bed. The animal may climb because the animal may not jump high enough to reach the surface of the bed in one jump. The climbing process may result in the pet pulling and sometimes tearing the bed linen. Pets also typically do not stay the same size. As the pet grows, it may be desired to replace a piece of animal furniture with a different type of furniture or a larger size of the same furniture.

With all of the different types of animal furniture that are available to accommodate the many needs of the pet and pet owner, there remains a need for a multiple function piece of animal furniture.

### BRIEF SUMMARY OF SOME OF THE PREFERRED EMBODIMENTS

These and other needs in the art are addressed by an animal housing. The animal housing may include a top and a plurality of sides. The plurality of sides may provide support to the top. In addition, the animal housing may include a base, wherein the plurality of sides are secured to the base by magnetic force. The animal housing may further include a thermoelectric cushion. In addition, the animal housing, may also include an air purifier.

The foregoing has outlined rather broadly the features and technical advantages of the present invention in order that the detailed description of the invention that follows may be better understood. Additional features and advantages of the invention will be described hereinafter that form the subject of the claims of the invention. It should be appreciated by those skilled in the art that the conception and the specific embodiments disclosed may be readily utilized as a basis for modifying or designing other structures for carrying out the same purposes of the present invention. It should also be realized by those skilled in the art that such equivalent constructions do not depart from the spirit and scope of the invention as set forth in the appended claims.

### BRIEF DESCRIPTION OF THE DRAWINGS

For a detailed description of the preferred embodiments of the invention, reference will now be made to the accompanying drawings in which:

FIG. 1 illustrates a front, top and side view of the multiple function animal furniture piece;

FIG. 2 illustrates a view of the multiple function animal furniture piece with the top extended up to open the furniture piece;

FIG. 3 illustrates a view of the multiple function animal furniture piece with a ramp member extended from the furniture piece;

FIG. 4 illustrates an embodiment of the multiple function animal furniture piece with a cushion material positioned on the top on which an animal may rest or sleep;

FIG. 5 illustrates a frontal side view of the ramp member;

FIG. 6 illustrates a side cross-sectional view of the ramp member showing a lip used to enable the ramp member to engage the furniture piece;

FIG. 7 illustrates a view down on the floor mat positioned on the furniture piece;

FIG. 8 illustrates a side cross-section view of the floor mat;

FIG. 9 illustrates a cross-section view of the cushion material positioned on the top of the furniture piece;

FIG. 10 illustrates a view of the back side of the furniture piece showing a rack means used to store a irate or screen;

FIG. 11 illustrates a design of a detachable grate used to cover the front openings of the piece;

FIG. 12 illustrates a cross-section view of the guide used for storing the grate;

FIG. 13 illustrates a front view of a multiple function animal furniture piece showing a front and top side and having a cage and an outer covering;

FIG. 14(a) illustrates an embodiment of a side of the outer covering;

FIG. 14(b) illustrates an embodiment of a side of the outer covering;

FIG. 15 illustrates an embodiment showing a cage cud an outer covering with the top side of the outer covering removed;

FIG. 16 illustrates a multiple function animal furniture piece comprising a cage;

FIG. 17 illustrates an embodiment of the multiple function animal furniture piece of FIG. 13 with a door in an open position;

FIG. 18 illustrates an embodiment of the multiple function animal furniture piece having a base and a orate;

FIG. 19 illustrates a top view of an embodiment of the multiple function animal furniture piece having a base;

FIG. 20 illustrates a top view of an alternate configuration of an embodiment of the multiple function animal furniture piece having a base; and

FIG. 21 illustrates a cross sectional side view of the multiple function animal furniture piece having a base and a case.

### DETAILED DESCRIPTION OF THE PREFERRED EMBODIMENTS

The multiple function animal furniture piece provides an animal owner with a system they may use for an animal throughout the life, of the animal. The multiple function animal furniture piece may serve as a training cage to train small animals such as puppies for living indoors. A detachable mat on the floor of the multiple function animal furniture piece provides for ease in cleaning animal waste. A removable front cover such as a trill may restrict undesired movement of the animal in and out of the furniture piece. In addition, as an animal gets older and/or bigger, the animal may no longer dwell inside the multiple function animal furniture piece. At this point, the multiple function animal furniture piece may function as a storage structure. Moreover, the multiple function animal furniture piece man have an attachable ramp member for use by an animal to climb to the top of the multiple function animal furniture piece structure. This ramp may be useful for smaller and older animals. The ramp may be stored inside the multiple function animal furniture piece when the ramp is not in use. The multiple function animal furniture piece may be portable and may be positioned adjacent the owner's bed. In this arrangement, the animal may easily move to the owner's bed. Further, the owner may easily sit on the top of the multiple function animal furniture piece. When an animal dies, the structure may be converted into a container (e.g., coffin) for burying the deceased animal.

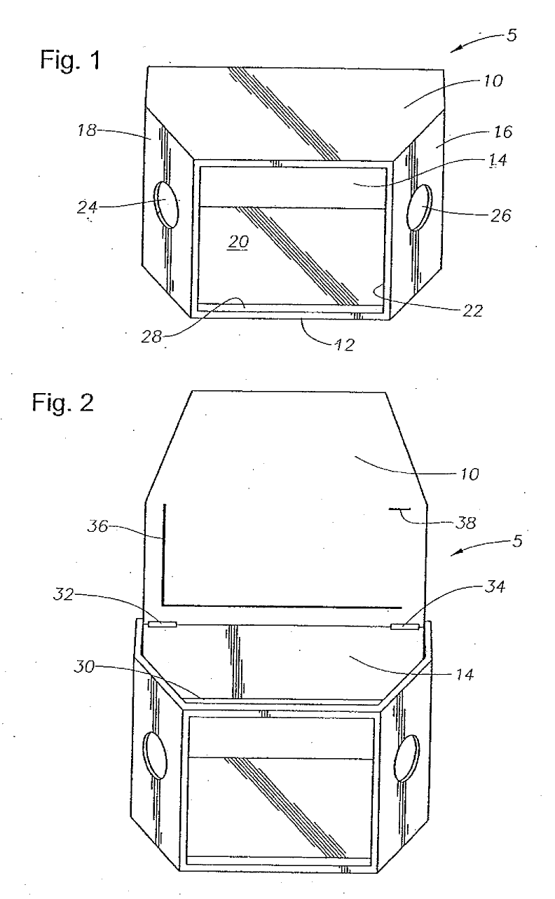

FIG. 1 shows a general design of the multiple function animal furniture piece 5. Other configurations such as those described in U.S. patent application Ser. No. 11/121,797 to the same inventor may be implemented to achieve the same results as the design described in FIG. 1. As shown, multiple function animal furniture piece 5 has a top 10, open front side 12, a back side 14, and multiple side walls 16 and 18. The number of sides may vary with the particular design shape. Multiple function animal furniture piece 5 may also contain a floor 20. The front side 12 has an opening 22, which covers a large portion of the front side 12. This large opening 22 allows for animals to enter multiple function animal furniture piece 5. Without limitation, the opening 22 may also allow for insertion of toys, food and water trays into the multiple function animal furniture piece 5. In addition, smaller openings 24 and 26 may be disposed in the side walls 16, 18. Without limitation, these openings 24, 26 may improve ventilation in multiple function animal furniture piece 5. The front side 12 also has a lip 28 that extends up from the base. Without limitation, lip 28 may prevent toys such as balls from accidentally rolling out of the multiple function animal furniture piece 5. In addition, a lip section (not illustrated) may also be attached to the top 10. Without limitation, such a lip section may serve as a restraining means to stabilize and keep a cushion stationary when an animal is resting, on it. In some embodiments, multiple side walls 16 and 18 provide support to top 10. It is to be understood that multiple function animal furniture piece 5 is not limited to multiple side walls 16, 18 but may instead include any number of sides (e.g., a plurality of side walls) depending, for instance, on the desired configuration.

It is to be understood that side walls 16, 18 may have one or more than one opening, respectively, and that side walls 16, 18 are shown in FIG. 1 with each side wall 16, 18 having one opening each (openings 24, 26) for illustration purposes only. It is also to be understood that back side 14 may have no such openings or one or more such openings. In an alternative embodiment, one or more of the sides may have no such openings. Openings in side walls 16, 18 and back side 14 may have any shape, configuration, and size suitable for allowing, ventilation and visibility into and out of multiple function animal furniture piece 5. For instance, such openings may have the shape of characters such as animals, cartoon figures, toys, lettering, numbering, symbols, and the like. Without limitation, examples of animal shapes include dogs, cats, and the like. In addition, without limitation, examples of cartoon figures include MICKEY MOUSE (which is a mark owned by Disney Enterprises, Inc.). SUPERMAN (which is a mark owned by DC Comics Warner Communications Inc.), and the like. Examples of toys include, without limitation, trucks, cars, airplanes, and the like. The character shape openings may be applied to the sides by any suitable process such as by a cutting apparatus, press, or the like.

Multiple function animal furniture piece 5 may be composed of any material suitable for the uses of multiple function animal furniture piece 5. For instance, multiple function animal furniture piece 5 may include wood, mesh, wire, plastic, metal, and the like. In such an embodiment, back side 14 and/or multiple side walls 16 and 18 may comprise wire, mesh, netting, weaving, and the like, preferably wire or mesh, and more preferably wire or wire-like material. Moreover, back side 14 and/or multiple side walls 16 and 18 may be composed of any porous material suitable for use as a side in an animal cage (e.g., porous metal or plastic siding). In an embodiment, back side 14 and/or multiple side walls 16 and 18 are composed of a plastic, wood, metal, or the like wire or wire-like material. One or more of multiple side walls 16 and 18 (preferably both side walls 16, 18) may be composed of such materials. In an embodiment (not illustrated), an outer covering may be disposed on the outside and/or inside surface of one or more of any side (e.g., front side 12, back side 14, side walls 16 and 18, top 10, floor 20) preferably an outer covering is disposed on the outside surface. In some embodiments, an outer covering is disposed on the outside surface of multiple side walls 16 and 18, back side 14 and/or top 10. The outer covering may cover any desired portion of a side. In addition, the outer covering may comprise any suitable covering for use with animals. For instance, the outer covering may be composed of natural or synthetic woods, veneers, vinyl, wicker, plastic, ceramic, and the like. In an embodiment, top 10 and/or front side 12 may also be composed of such plurality of openings and/or alternatively may also include such an outer covering. In alternative embodiments, at least one side and/or wall of multiple function animal furniture piece 5 comprises a substantially solid material.

FIG. 2 shows the multiple function animal furniture piece 5 with the top 10 extended in an upward position, which thereby opens up multiple function animal furniture piece 5. As shown, a bar 30 extends across the front side of multiple function animal furniture piece 5 and man serve as a rest bar for the top 10. Hinges 32 and 34 attach the top 10 to the back side 14 and allow the top 10 side to open and close as desired. Attached to the inside surface of the top 10 side is a rack member 36 for holding a ramp member when the ramp member is not in use. Rack, member 36 may have any suitable shape (e.g., an L-shape) that fits with the shape of a rectangular ramp member. In an embodiment, rack member 36 is a groove with a generally u-shape in which the ramp member is placed. When the ramp member is placed in rack member 36, a latch 38 secures the ramp in rack member 36.

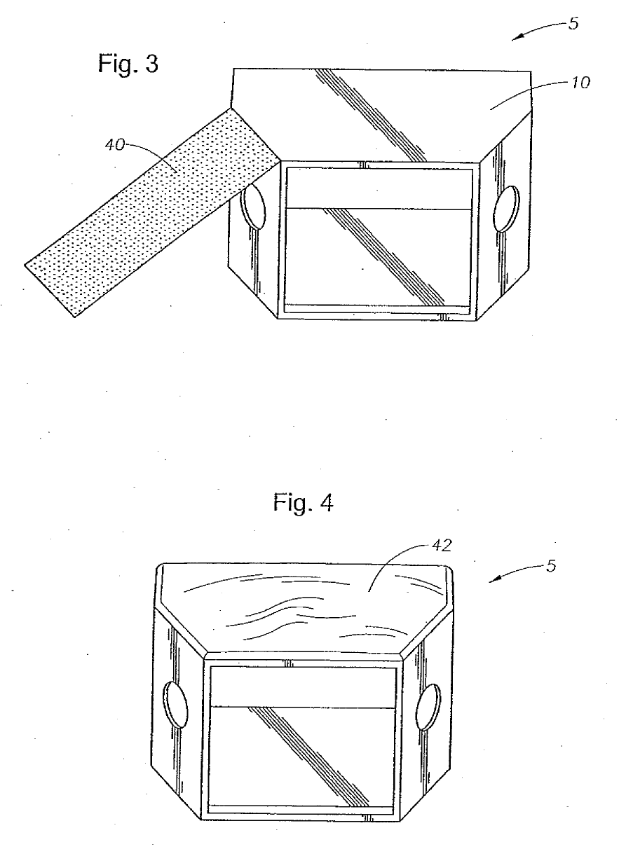

FIG. 3 shows a configuration of the multiple function animal furniture piece 5 with a detachable ramp 40 engaged at one side. In this configuration, an animal may climb to the top 10 of multiple function animal furniture piece 5 without the need to climb up on a bed or other piece of furniture. Depending on the height of multiple function animal furniture piece 5, the length of the ramp 40 may vary such that the inclination angle formed by the engagement of the ramp 40 to multiple function animal furniture piece 5 is not too steep for the animal to safely climb.

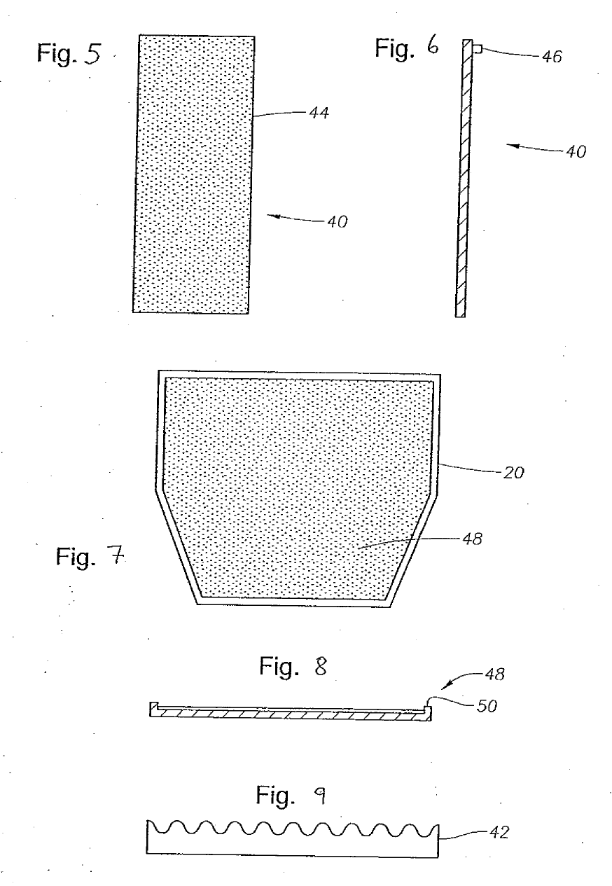

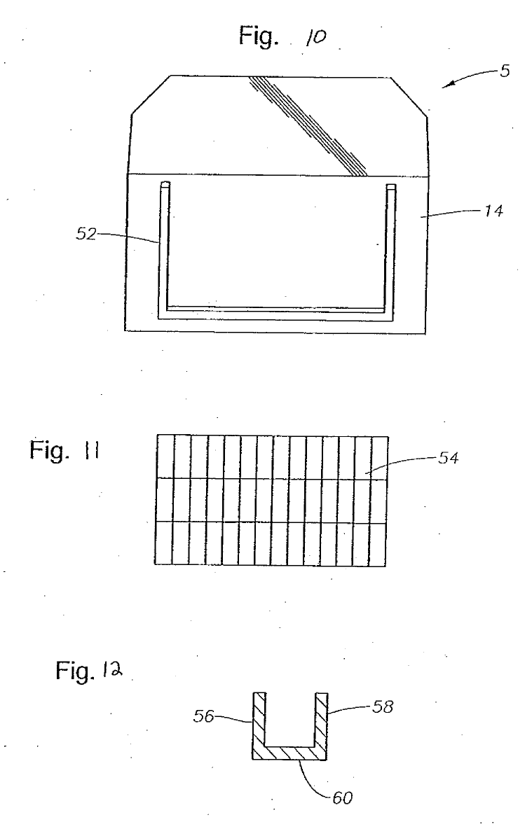

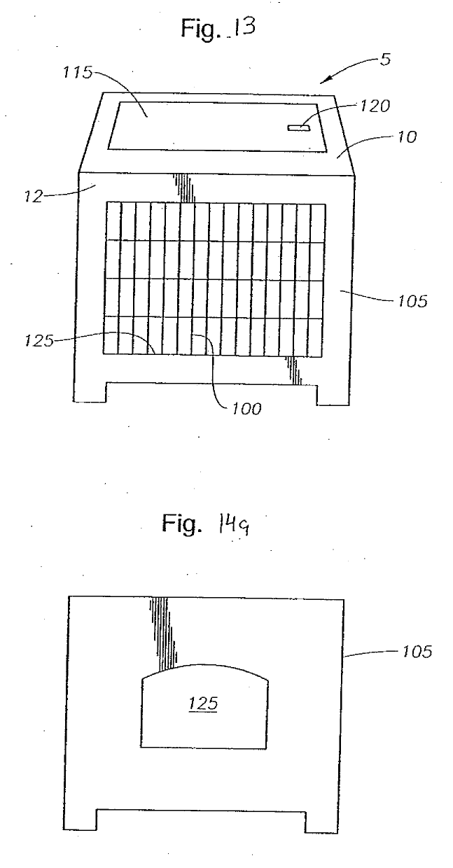

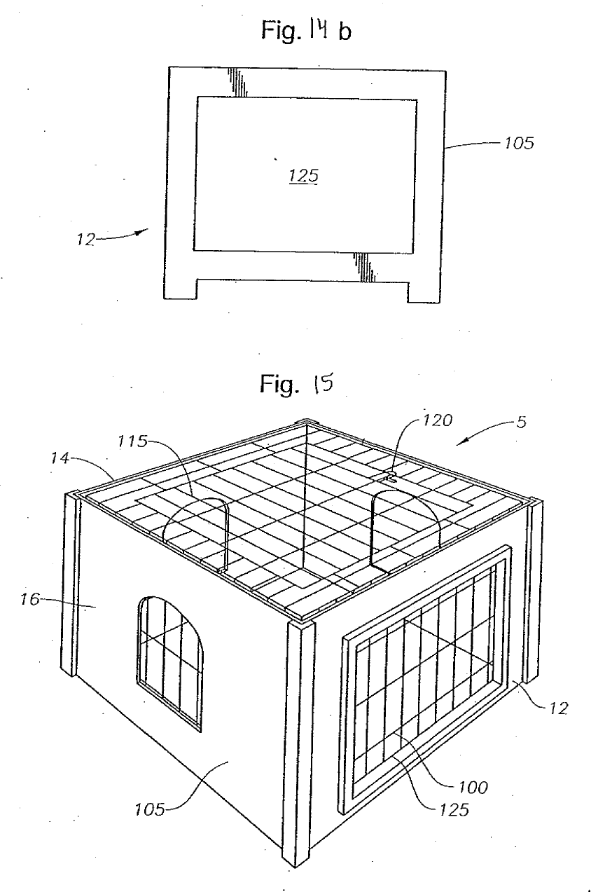

FIG. 4 shows the multiple function animal furniture piece 5 with the cushion material 42 positioned on the top 10. As mentioned, the cushion material 42 may serve as a cushion on which an animal may rest or sleep. FIG. 9 shows the cross-section of a typical cushion that may be used with multiple function animal furniture piece 5. Other types of cushions with, varying shapes may also be implemented in a similar manner.

FIG. 5 shows a front view of the ramp member 40. Attached to this front side is a fiber-type material 44 such as a cloth or carpet material. Fiber-type material 44 increases the friction of the ramp member 40 such that an animal may have improved traction as the animal climbs the ramp member 40 to the top 10. FIG. 6 shows a side cross-sectional view of the ramp member 40. The ramp member 40 contains a lip 46 that engages the edge of the top side securing the ramp member 40 to multiple function animal furniture piece 5.

FIG. 7 shows a view of the floor 20 of multiple function animal furniture piece 5 on which mat material 48 is disposed. Mat material 48 may be an elastic or rubber type of material or other type of water-proof material. The mat material 48 extends up the side walls of multiple function animal furniture piece 5 thereby covering substantially all of the floor 20. This mat material 48 provides a way to easily clean multiple function animal furniture piece 5. As mentioned, multiple function animal furniture piece 5 may serve as a house for a smaller pet. Typically, these pets are initially not house trained. Any waste secreted by the animal may not penetrate to the floor. When cleaning, the owner may raise the top 10 of multiple function animal furniture piece 5 and remove the mat material 48. The owner may then clean the mat material 48. FIG. 8 shows the cross-section of the mat material 48. The edge 50 of the mat 48 has a lip shape that prevents substances from escaping the mat material 48 surface. The mat material 48 may also have a ridged surface similar to FIG. 9 for channeling liquid. In alternative embodiments, multiple function animal furniture piece 5 may comprise mat material 48 and/or a thermoelectric cushion (not illustrated). In an embodiment, the thermoelectric cushion is disposed on mat material 48. In some embodiments, multiple function animal furniture piece 5 comprises more than one thermoelectric cushion. The thermoelectric cushion may comprise any desired shape and size. For instance, the thermoelectric cushion may be suitable as an animal bed. The thermoelectric cushion may provide heating and/or cooling functions. Without limitation, a commercial example of a thermoelectric cushion is the THERMOELECTRIC COOLER & PET BED, which is a thermoelectric bed commercially available from Laurina Company Limited. In alternative embodiments, a thermoelectric cushion may be disposed on top 10.

FIG. 10 shows the back side 14 of multiple function animal furniture piece 5. Attached to this back side 14 is a storage rack 52 similar to the rack member 36. Without limitation. Storage rack 52 may hold grate 54, which is shown in FIG. 11. Storage rack 52 has a general shape that matches the shape of the orate 54. FIG. 12 shows a cross-section of the storage rack 52. Storage rack 52 has two sides 56 and 58 and a base 60. The two sides 56, 58 are perpendicularly attached to the base 60. One side is also attached to the back side 14. When the grate 54 is not in use grate 54 may be slid into storage rack 52. Grate 54 may be used to cover front opening 22. Grate 54 may have different designs and may also be composed of screen material. In addition, other conventional materials such as plastic may be used as this front opening 22 cover.

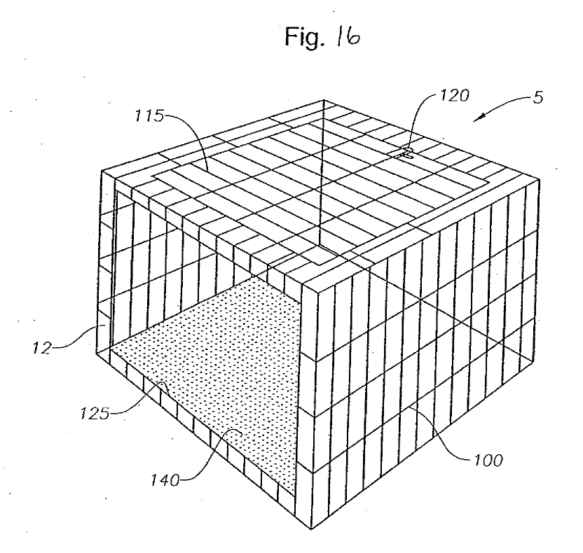

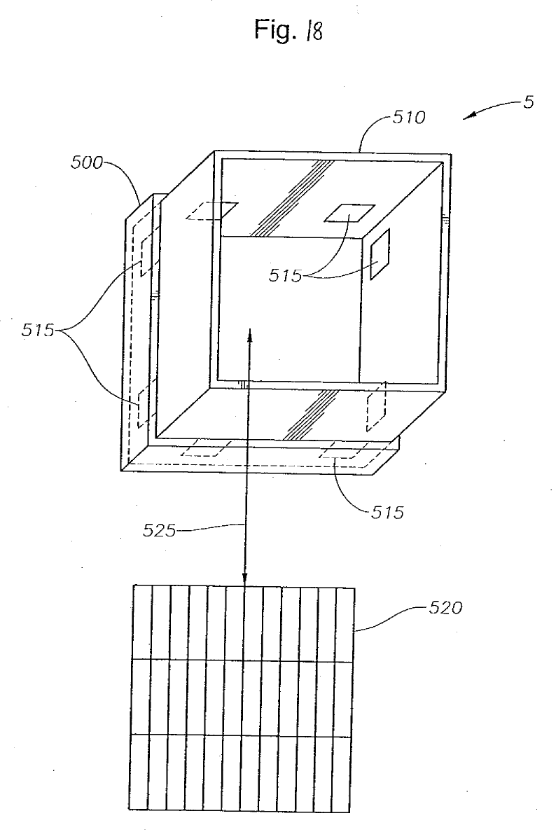

In an embodiment, multiple function animal furniture piece 5 comprises a cage and/or an outer covering on the top side 10, back side 14, front side 12, and sides 16, 18 of the cage (e.g., on all sides of the cage). In an alternative embodiment, multiple function animal furniture piece 5 also comprises an outer covering on bottom side (e.g., floor 20). FIG. 13 illustrates a front view of such an embodiment showing front side 12 and top side 10. In such an embodiment, multiple function animal furniture piece 5 comprises a cage 100 and an outer covering 105. Cage 100 may comprise any suitable material for containing an animal. For instance, care 100 may comprise metal, wood, plastic, ceramic, and the like. The sides of cage 100 may be attached by any suitable means. In an embodiment, top side 10 has a door 115 that is movably openable and closable. Door 115 comprises a latching, mechanism 10 by which door 115 may be secured to top side 10 and substantially prevented from movement. Latching mechanism 120 may comprise any suitable mechanism for opening and closing door 115 and also suitable for securing door 115 against movement relative to top side 10. It is to be understood that FIG. 13 shows door 115 in a closed position. FIG. 17 illustrates an embodiment in which door 115 is in an open position. As shown in FIG. 13, outer covering 105 on front side 12 has openings 125 by which cage 100 is exposed therethrough. In an embodiment, at least one side of outer covering 105 has an opening; alternatively front side 12, sides 16, 18, and back side 14 of outer covering 105 has such openings; and alternatively all sides of outer covering 105 have an opening. FIGS. 14(a) and 14 (b) show embodiments of sides of outer covering 105 having different opening configurations. For instance. FIG. 14(a) illustrates outer covering 105 having opening 125 therethrough. Outer covering 105 having such opening 125 may be suitable as side 16, side 18, and/or back side 14. It is to be understood that outer covering) 105 may have more than one opening 125. Opening 125 may have any desirable shape and size. FIG. 14(b) illustrates an embodiment of front side 12 having outer covering 105 with opening 125. In such an embodiment, opening 125 may be of sufficient size to allow a desirable animal to pass therethrough. Further referring to FIG. 13, in an alternative embodiment, front side 12 of cage 100 may be movable attached to side 16 or 18 of cage 100. In such an embodiment such front side 12 of cage 100 may be sufficiently movable to allow a desirable animal to pass through opening 125 in such front side 12. In such an alternative embodiment such front side 13 of cage 100 may also be sufficiently closable to prevent the desirable animal from passing through opening 125 in front side 12. In an alternative embodiment (not illustrated) another side is openable to allow a desirable animal to pass through an openings 125 therein into multiple functional animal furniture piece 5. In such an alternative embodiment top side 10 may or may not be openable. For instance FIG. 16 illustrates an embodiment of multiple functional animal furniture piece 5 comprising a cage 100 and no outer covering 105. As shown in FIG. 16, front side 12 has movably attached door 115 with a latching mechanism 120. It is to be understood that FIG. 16 shoos door 115 in the open position and disposed on top of top side 12 thereby providing opening 125 in cage 1100.

It is to be understood that outer covering 105 may be secured to cage 100 or not secured to cage 100. In an embodiment in which outer covering 105 is secured to cage 100, outer covering 105 may be secured by any suitable method. For instance, outer covering 105 may be secured to cage 100 by one or more grooves in outer covering, 105. As an example portions of cage 100 may be suitably secured into a groove disposed in outer covering 105.

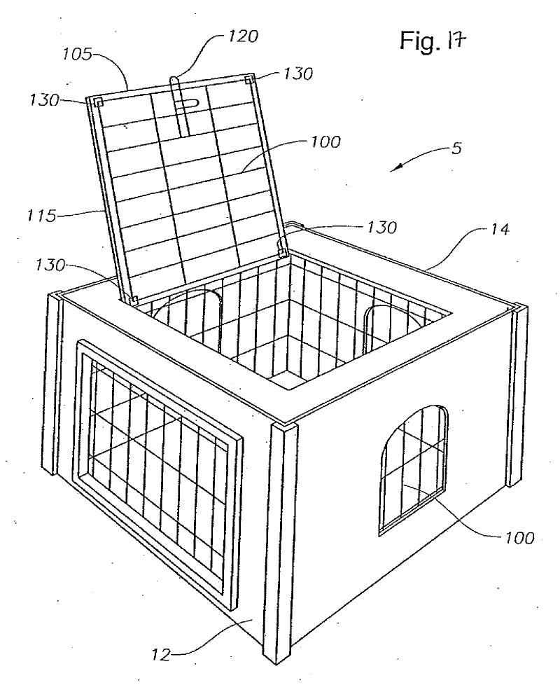

FIG. 15 illustrates an embodiment of FIG. 13 with the outer covering 105 of top side 10 removed to expose top side 10 of cage 100. As shown, door 115 has latching mechanism 120.

The sides of outer covering 105 may be attached by any suitable method. For instance, the sides may be connected by magnets, glue, hooks, and the like. In an embodiment, the sides are connected by magnets. Each side of outer covering 105 may have any number of magnets suitable to sufficiently secure one such side to another such side (e.g., by magnetic attraction to another side). The magnets may be secured to the exterior of the outer covering 105 (e.g., by glue) and/or may be embedded in the outer covering, 105. It is to be understood that each side of outer covering 105 may be separated from another side by applying sufficient force to overcome the force of the magnet. Thereby, one or more sides of outer covering 105 may be removed to expose cage 100. FIG. 16 illustrates an embodiment in which all sides of outer covering 105 have been removed. In an alternative embodiment, manners disposed on the outer covering 105 may also be used to secure outer covering 105 to cage 100. For instance. FIG. 17 illustrates an embodiment in which magnets 130 on the outer covering 105 of door 115 secure such outer covering 105 of door 115 to the cage portion 105 of door 115. As shown in FIG. 16, multiple function animal furniture piece 5 may also comprise a detachable mat 140.

As mentioned, the structure and system of the multiple function animal furniture piece 5 provides the owner of an animal with the versatile means for providing care for the animal. This structure and system may accommodate activities for animals of all ages and sizes. The structure serves as both a dwelling for small animals as well as a training cave to teach certain behaviors. In addition, an internal storage capacity is provided. The ability to store the detachable components of the system within the structure facilitates managing this system. The portability of the structure enables the owner to position it at any location. As mentioned, owners may use it as a bed for the animal or as a means for the animal to climb into the owner's bed. The attachable ramp may also facilitate animals of all ages and sizes in climbing the ramp to the top side of the structure. At the animal's death, the structure may serve as a container coffin in which to bury the animal.

It is to be understood that sides 12, 14, 16, and 18 are for illustration and explanatory purposes and embodiments described for one of such particular sides may be suitable for one or more other of such sides.

FIG. 18 illustrates an embodiment in which multiple function animal furniture piece 5 comprises a base 500 and an outer covering 510. Multiple function animal furniture piece 5 may optionally comprise a cage 100 (not illustrated). Base 500 comprises any material suitable for use with an animal cage. Without limitation, examples of suitable materials include plastic, ceramic, stainless steel, and the like. Preferable materials include plastic. Base 500 preferably comprises a similar configuration to that of outer covering 510. In addition, base 500 has a width and length suitable for outer covering 510 to be disposed inside of base 500. Preferably, outer covering 510 is disposed within sufficient proximity to base 500 for magnets 515 disposed within base 500 and/or outer covering 510 to provide a desirable stability (e.g., lateral and vertical stability) to outer covering 510. Base 500 may comprise any height suitable for providing strength and integrity to outer covering 510. In an embodiment, the height of base 500 is less than the height of outer covering 510.

As shown in FIG. 18, outer covering 510 comprises magnets 515. In alternative embodiments (not illustrated), base 500 and/(or outer covering 510 comprise magnets 515. Magnets 515 may be attached to base 500 and/or outer covering 510 and/or mar be embedded in base 500 and/or outer covering 510. In such an embodiment, multiple function animal furniture piece 5 may comprise any desired number and type of magnets. In an embodiment (not illustrated), magnets 515 are disposed in base 500. In such an embodiment, metal (or like material that is attractive to a magnetic force) may be attached to outer covering 510 in sufficient locations that when outer covering 510 is placed in base 500, the magnets 515 secure outer covering 510 to base 500. The metal may be attached to outer covering 510 by any suitable means such as by glue. For instance, the metal may be disposed in locations on outer covering 510 that correspond to locations on base 500. The magnets 515 also may serve to laterally and vertically secure cage 100.

As further shown in FIG. 18, multiple function animal furniture piece 5 may also comprise a grate 520. Grate 520 comprises any suitable grate-like shape and configuration. Without limitation, grate 520 comprises openings of a sufficient diameter to allow animal waste to fall through grate 520. In another embodiment, a pan (not illustrated) is disposed beneath grate 520. The pan may be comprised of any suitable material. Without being limited by theory, animal waste that falls through grate 520 is captured by the pan. Grate 520 and the pan are slidably insertable into base 500. Grate 520 and the pan may be inserted and removed from base 500 in the directions as illustrated by arrow 525. In an embodiment (not illustrated), grate 520 and the pan are inserted into base 500 through an opening, in base 500. In some embodiments, a thermoelectric cushion may be disposed on the crate.

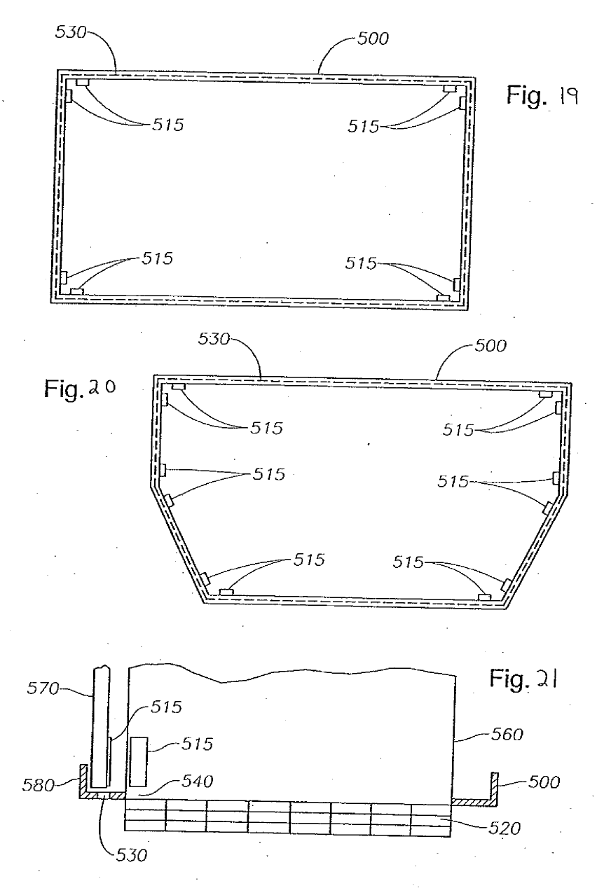

FIG. 19 illustrates a top view of an embodiment of base 500. In such an embodiment base 500 comprises a plurality of drain holes 530. Without being limited by theory, drain holes 530 allow fluid such as water to pass into the pan. FIG. 20 illustrates an embodiment of base 500 having a different configuration than that shown in FIG. 19.

FIG. 21 illustrates a cross sectional side view of an embodiment of base 500 having a lip 580. In such an embodiment, lip 580 provides a cavity 540 in which grate 520 may be inserted. For instance, lip 580 comprises a raised portion of base 500. The walls 570 and corners 560 of base 500 are disposed upon lip 580, which provides cavity 540 for insertion of grate 520. In such an embodiment, the pan is disposed beneath grate 520, which provides spacing in cavity 540 between the grate 520 and the pan. Lip 580 may also comprise one or more drain holes 530. As further illustrated, magnets 515 may disposed on corner 560 and wall 570.

In an embodiment (not illustrated) multiple function animal furniture piece 5 comprises an air purifier. In alternative embodiments, multiple function animal furniture piece 5 comprises more than one air purifier. Any air purifier suitable for use in removing contaminants from the air within multiple function animal furniture piece 5 may be used. Without limitation, examples of suitable air purifiers include mechanical filter devices, absorbent devices (e.g., devices that filter air through absorbents such as charcoal), and air ionizers. Any air ionizer suitable for removing particulate from air in multiple function animal furniture piece 5 may be used. An example of an air ionizer is an electrostatic precipitator. Electrostatic precipitators refer to a particulate collection device that removes particles from air using the force of an induced electrostatic charge. Without limitation, examples of commercial electrostatic precipitators include the HYBRID GP, which is an electrostatic precipitator commercially available from The Sharper Image. The air purifier may be disposed at any suitable location on multiple function animal furniture piece 5 by which the air purifier may remove particulate from the air within multiple function animal furniture piece 5. For instance, one or more air purifiers may be disposed on the inside of, a side of multiple function animal furniture piece 5.

Although the present invention and its advantages have been described in detail, it should be understood that various changes, substitutions and alterations may be made herein without departing from the spirit and scope of the invention as defined by the appended claims.

What is claimed is:

1. An animal housing, comprising:
a top;
a plurality of sides, wherein the plurality of sides provide support to the top; and
a base, wherein the plurality of sides are secured to the base by magnetic force.

2. The animal housing of claim 1, further comprising a thermoelectric cushion.

3. The animal housing, of claim 2, wherein the thermoelectric cushion provides a heating function, a cooling function, or both.

4. The animal housing of claim 2, wherein the thermoelectric cushion is disposed within the animal housing.

5. The animal housing of claim 2, wherein the thermoelectric cushion is disposed on the top.

6. The animal housing, of claim 1, further comprising an air purifier.

7. The animal housing of claim 6, wherein the air purifier comprises a mechanical filter device, an absorbent device, or an air ionizer.

8. The animal housing of claim 6, wherein the air purifier comprises an air ionizer.

9. The animal housing of claim 6, wherein the air purifier comprises an electrostatic precipitator.

10. The animal housing of claim 1, wherein the base comprises a plurality of base magnets.

11. The animal housing of claim 10, wherein the plurality of base magnets secure the plurality of sides to the base.

12. The animal housing of claim 1, wherein the plurality of sides comprise natural or synthetic wood, veneer, vinyl, wicker, plastic, or ceramic.

13. The animal housing of claim 1, wherein the plurality of sides comprise natural or synthetic wood.

14. The animal housing of claim 1, further comprising a cage.

15. The animal housing of claim 14, wherein the cage is disposed within the plurality of sides.

16. The animal housing of claim 14, wherein the cage and the plurality of sides are secured to the base by a plurality of base magnets.

17. The animal housing of claim 1, wherein one of the plurality of sides is secured to two of the plurality of sides by magnetic force.

18. The animal housing of claim 1, further comprising a grate.

19. The animal housing of claim 18, further comprising a pan.

20. The animal housing of claim 18, wherein a thermoelectric cushion is disposed on the grate.
